(19) United States
(12) Patent Application Publication
(10) Pub. No.: US 2016/0371714 A1
(43) Pub. Date: Dec. 22, 2016

(54) SYSTEM AND METHOD FOR UTILITY UNIT COMPENSATION OF DISADVANTAGED ENTITIES IN A UTILITY TRANSACTION

(71) Applicant: Knotis Inc., Seattle, WA (US)

(72) Inventors: Josie M. Imlay, Seattle, WA (US); McLean R. Reiter, Seattle, WA (US)

(73) Assignee: Knotis Inc., Seattle, WA (US)

(21) Appl. No.: 15/187,706

(22) Filed: Jun. 20, 2016

Related U.S. Application Data
(60) Provisional application No. 62/182,309, filed on Jun. 19, 2015.

(51) Int. Cl. G06Q 30/02; G06Q 40/04

(52) U.S. Cl. CPC G06Q 30/0207; G06Q 40/04

(57) ABSTRACT

A system and method for the compensation of an entity, such as business or person, which is disadvantaged in a utility transaction in first utility unit, such as money, with at least a second utility unit, such as a coupon or voucher, such that the overall disadvantage to an entity from the transaction, economic or otherwise, is minimized. The system and method can be used in multiparty transactions where each party has a different interest in the transaction, such as with a restaurant, waiter, and customer to minimize the adverse effect to the waiter from tip reduction. The system and method can also be used to minimize the disadvantage to customers from stores that sell goods or services in a high-expense location who need to charge more because of the additional overhead. The system can also be used in other multiparty non-monetary transactions, such as dynamic resource allocation.

### CROSS-REFERENCE TO RELATED APPLICATION

This application claims the benefit of U.S. Provisional Patent Application No. 62/182,309, filed on Jun. 19, 2015, the entirety of which is hereby incorporated herein by this reference.

### BACKGROUND OF THE INVENTION

1. Field of the Invention

The present invention generally relates to entities that participate in utility exchange transactions, such as economic purchases with multiple party interests. More specifically, the present invention relates to the compensation of an entity, such as business or person, which is disadvantaged in a utility transaction in first utility unit, such as money, with a second utility unit, such as a coupon or voucher, so that the overall disadvantage to the party is minimized.

2. Background of the Invention

In utility unit transactions, such as an economic payment for goods or services, there are often disadvantages to the entities participating based upon the individual interests of the entities involved. This is particularly acute where there is a multiparty transaction where each party has its own interest and a plurality of actors in the transaction can shift he transaction to disadvantage minority parties. For example, in a service transaction that involves a customer, server and business, each of the entities has different economic interests in the transaction. In the example of a restaurant setting, the restaurant may want to entice a customer to dine using a coupon that causes a discount to the price of the meal. The waiter is compensated from tips based upon a percentage of the price of the meal charged to the customer. If the coupon is used by the customer, then the total amount of the meal is accordingly reduced and if the customer does not notice the reduction in price, he may tip the waiter at a lesser amount than the full meal normally costs. Thus, in this economic transaction there is a benefit to the restaurant in getting a customer to pay money for a meal using the coupon, where the customers might not have otherwise dined at the restaurant at all. There is also a benefit to the customer who gets the discounted food. But, the waiter is harmed in the transaction from the lower tip.

In another example of a disadvantageous utility transaction, a store selling goods can be disadvantaged on their cost of goods that it needs to charge customers due to high overhead, which can be caused by a variety of reasons such as real estate, taxes, economies of scale and the like. A customer may have a choice of where and when to buy a good such that a customer can arbitrage the cost of the good based upon the specific store where the good is purchased. For example, the customer may live in the urban area of a city, where the costs of everything is high, and wait until a weekend or other time to venture to a more remote store and buy in bulk to economize real estate overhead and economy of scale. The urban store is at a disadvantage because it is difficult to create an adequate incentive, such as through sales or coupons, to have the customer come and spend money at the urban store due to the increased expense of the goods or services, even though it may be more convenient. Furthermore, the amount of potential discount need to be given at the urban store to change customer behavior to not go to a larger, remote discount competitor store may be too great to overcome to allow a profitable transaction for the urban store in a customer transaction.

Disadvantaged parties can also occur in multiparty transactions that do not involve direct payment of money. For example, in a resource allocation transaction, such as a need for multiple parties to access as resource such as network bandwidth, the bandwidth provider can be influenced on allocation by one or more of the parties provided other advantages to the provider, such as allowing additional advertising space within a stream. Thus, the party that will allow the provider the greatest amount of advertising within the stream often wins the resource allocation.

### SUMMARY OF THE INVENTION

A system and method for the compensation of an entity, such as business or person, which is disadvantaged in a utility transaction in first utility unit, such as a currency, with at least a second utility unit, such as a coupon or voucher that will have some value relation to the first utility unit, such that the overall economic disadvantage to an entity from the transaction is minimized. The system and method can be used in multiparty transactions, such as with a restaurant, waiter, and customer to minimize the adverse effect to the waiter from tip reduction when the customer gets a discount on a meal, while maintain the same advantages to the other parties.

The system and method can also be used to minimize the disadvantage to stores that sell goods or services in a high-expense location who need to charge more because of the additional overhead. Through the use of coupons or other second utility units, the system allows a customer to shop at one store and receive a lower price at checkout, such as a calculated lowest area price for a good, with the price difference paid in the second utility unit, such as a coupon for the good either being applied at retail checkout or credited to the account of the customer. The secondary utility unit incentive can be from other pooled retailed coupons available such that the high-price retail store does not have to use unduly expensive coupon incentives to entice customers to shop there.

Additionally, the present system and method can create a second utility unit market, e.g., an aggregation of coupons of many entities, which can allow expanded secondary utility unit use, such as coupon use, from the expanded market, and all of the increased sales to the entities therefrom if embodied as a coupon market. The system and method can thereby benefit the store, the third party system itself, and the customer in the overall utility transaction.

Further, the system and method can be used in multiparty transactions that do not involve direct payment of money. For example, in a resource allocation transaction, such with a network provider allocating bandwidth based one or more of the parties providing the provider advertising space within a stream, a party can provide secondary utility units to the provider to influence the bandwidth allocation. Thus, a party who may be disadvantaged in a pure bandwidth stream allocation as a first utility unit, can influence the provider by providing lesser advertising space in the allocated bandwidth and add second utility units, such as virtual coupons, to the stream to increase the advertising effectiveness, e.g., click-throughs, etc. Such incentive can induce a provider to let a party get a greater allocation of bandwidth with less advertising space for the provider based on the value to the provider of the secondary utility units.

### BRIEF DESCRIPTION OF THE DRAWINGS

FIG. 1 is a representative diagram of the system to effect secondary utility unit compensation of disadvantaged entities in a first utility unit transaction with the use of secondary utility units through the use of mobile devices in communication with a data center across the Internet/cellular network.

FIG. 2 is a representative diagram of a waiter taking a picture of a restaurant bill that has been discounted and the tip amount is shown.

FIG. 3 is a representative diagram of customer at checkout at a retail store where a discount is applied at checkout for at least some of the items purchased by a customer who is a user of the system.

FIG. 4 is a flowchart of one embodiment of a process to compensate a waiter in a disadvantaged transaction in a discounted restaurant purchase by a customer who inadvertently tips based upon the discounted bill amount.

FIG. 5 is a flowchart of one embodiment of a process to compensate a customer at a retail store for the purchase of expensive items that can be found at lower prices in the region of the customer, and the retail store can benefit from the pooling of coupons into a secondary utility unit market.

### DETAILED DESCRIPTION

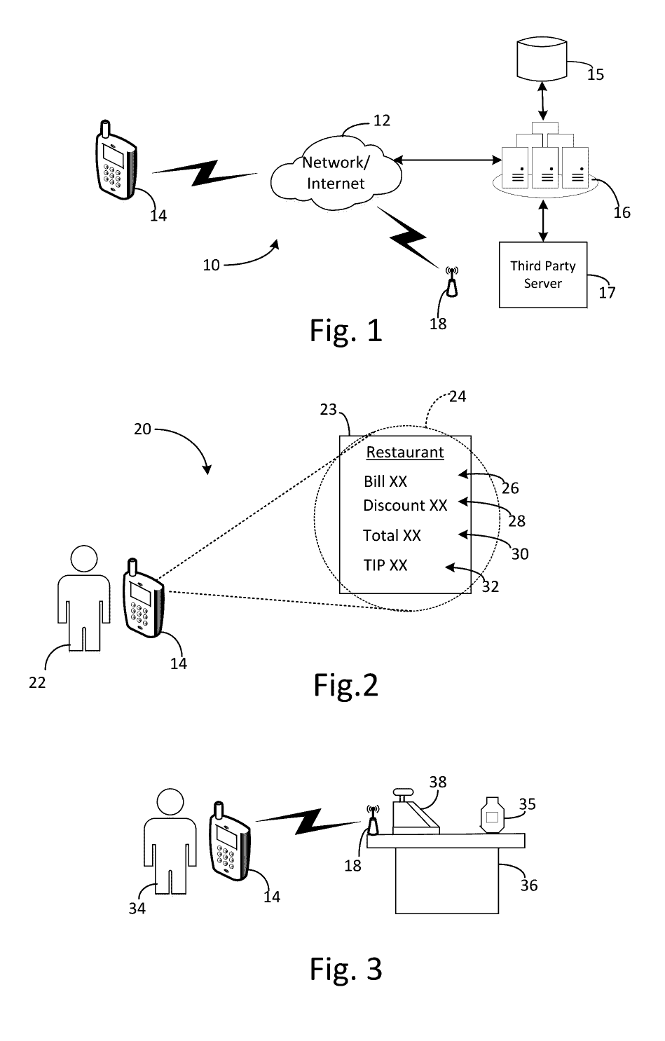

Briefly described, FIG. 1 is a representative diagram of the system 10 to effect secondary utility unit compensation of disadvantaged entities in a first utility unit transaction through the use of mobile devices 14 in communication with a data center 16 across the Internet/cellular network 12. The system 10, in this embodiment, includes a wireless terminal 18 for a point-of-sale electronic payment transaction. The data center 16 can include one or more computer devices that are physically located together, or can be networked together, or can exist completely as a cloud-based service. Through the use of the mobile device 14 and wireless terminal 18, the data center 16 can receive data of an economic transaction between entities, such as business or person, that disadvantaged in a utility multiparty transaction in first utility unit, such as a currency or resource or other unit of value, with at least a second utility unit, such as a coupon or voucher or resource that will have some value relation to the first utility unit, such that the overall disadvantage to an entity from the multiparty transaction is minimized.

The system uses wireless network 12, such as the Internet, to communicate with a data center 16 that can include one or more servers and networked computer devices as is known in the art. The data center 16, as embodied here, includes a database 15 that stores information of potential multiparty purchase transactions, such a purchase transaction for specific goods or services that can be purchased, or links to other data sources for specific purchase, e.g., a manufacturer's website. The database 15 also contains second utility units, such as coupons, vouchers, resources, etc., that are potentially applicable to potential transactions, where the second utility units have a different value than a first utility unit for the multiparty transaction that can be used within a purchase or other utility transaction.

The data center 16 can also include connectivity to a third party server 17, such as a manufacturer, distributer or retailer server that the data center 16 can connect to when a multiparty transaction is request by a user of the system 10 as further described herein. For example, upon a user requesting assistance in a multiparty transaction, as shown in the restaurant bill of FIG. 2, the data center 16 can add second transactional value units, such as coupons, to the potential purchase transaction to make the user whole if the tip if not reflective of the true value of the meal.

In one embodiment, the database 15 further stores a plurality of accounts for potential parties to multiparty transactions such that the data center 16 further allocates secondary utility units to the account of a party that is disadvantaged in a multiparty transaction. For example, a waiter could have an account that holds secondary units that is credited each time the waiter is disadvantaged by a low tip due to the application of a coupon to a meal purchase. Thus, the system 10 can apply the secondary utility unit to account of the waiter, or can be embodied to apply secondary units within the multiparty transaction itself.

In one example, the system 10 can be used in multiparty transactions, such as with a restaurant, waiter 22, and customer to minimize the adverse effect to the waiter from tip reduction when the customer gets a discount on a meal, as shown in one embodiment of FIG. 2. FIG. 2 is a representative diagram of a waiter 22 taking a picture 24 of a restaurant bill 23 that has been discounted, as shown at discount 28, and the tip amount 32 is shown. Through the use of the system, making a tip-dependent waiter 22 whole when a coupon is used by a customer, and the customer does not adjust the tip accordingly to be based on the original amount. In this embodiment, coupons (a second utility unit) will be given to the waiter 22 for the lost tip money revenue (a first utility unit).

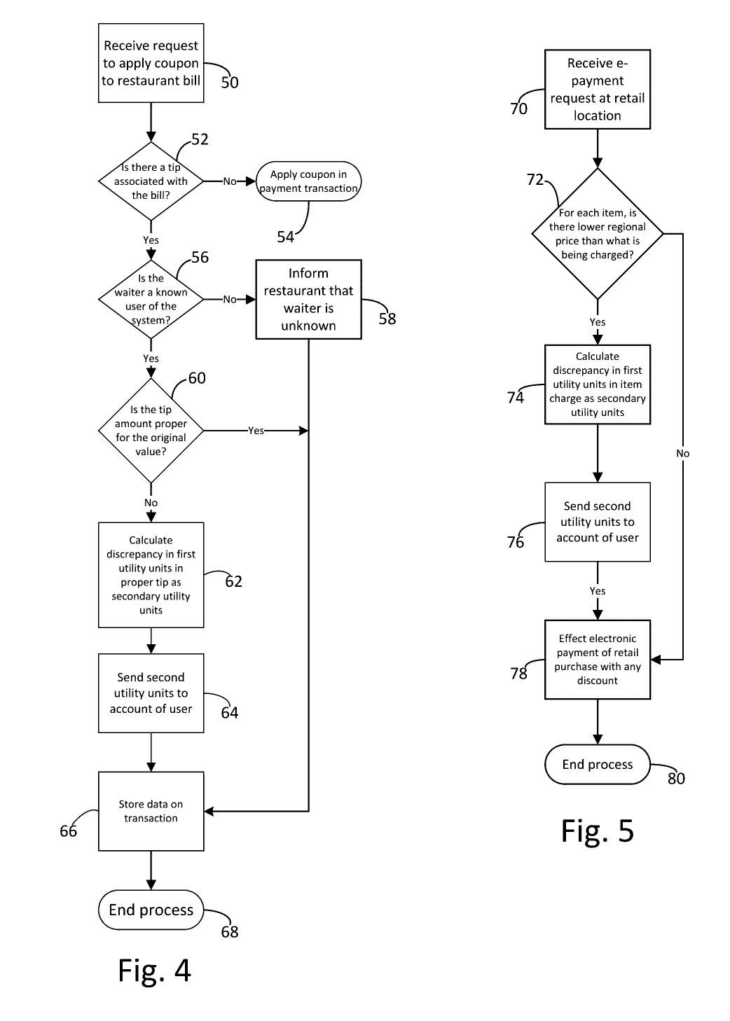

Here, the restaurant bill 23 is shown listing the name of the restaurant, the full bill amount 26, the discount 28, then total amount 30 owed by the customer, and the amount of tip 32 paid the customer. The waiter 22 will take a picture 24 of the bill 23 with the mobile device 14 and transmit is back to the data center 16 across the cellular network or internet 12 such that the data center 16 can perform the step of determining if a payment of secondary units is owed to the account of the waiter 22 for the transaction. One embodiment of such calculation process is more fully set forth in FIG. 4. The process of determining if the restaurant bill 23 was unfair to the waiter 22 can also be done based on the payment method used to pay the bill 23. For example, if the data center 16 were embodied to also effect an electronic payment and applied the coupon discount 28 to the transaction, the data center 16 could be aware of the entire transaction and credit the waiter's 22 account with secondary units accordingly. The credit would be stored in the account of the waiter in the database 17.

FIG. 3 is a representative diagram of one embodiment of the system where a customer 34, who is a user of the system, is at checkout counter 36 at a retail store where a discount is applied at checkout for at least some of the items purchased by the customer, such as item 35. The checkout counter 36 is shown here embodied with the cash register 38 including a wireless payment terminal 18. Thus, in this embodiment, the customer 34 has a mobile wallet on the mobile device that can effect the electronic payment transaction for the item 35 such that a discount in secondary utility units can be applied to offset the increase of item price due to high overhead at the retail location. The payment system can also be third party server 17 that works with the multiparty system. FIG. 5 shows one embodiment of this process in greater detail. The system would accordingly have an active database 15 of costs for the relevant goods in the predefined geographical area to measure the discounts given.

In this embodiment, the payment system allows for direct application of the secondary utility units to the first utility unit payment transaction, e.g., the money payment for the item 35 can be discounted. However, the system can be embodied such that the second utility unit determination and allocation occur outside of the electronic payment, such as by piggybacking on an existing credit card payment system, or by the use of a shopper card or other user id in a cash payment. Furthermore, the system can apply secondary utility units to the account of a user of the system for use in a later economic transaction, such as a credit of secondary utility unit in a general account, which could be a coupon unit, e.g., $5 off your next purchase at a grocery store, or generic coupon or voucher credit that has a currency value in a separate transaction, such as $1 discount in any transaction using a specific electronic payment system.

FIG. 4 is a flowchart of one embodiment of a process to compensate a waiter 22 in a disadvantaged transaction in a discounted restaurant purchase by a customer who inadvertently tips 32 on the discounted total 30 bill amount, such as is also shown in the representative diagram of FIG. 2. It should be noted that this is a different embodiment than in FIG. 2 where a picture 24 is used to convey the information of the restaurant bill, and both of these embodiments can be used in conjunction. The process begins with the receipt of a request to apply a coupon in a restaurant transaction, as shown at step 50. In this embodiment, the application of the coupon occurs through an electronic payment system like that shown in FIG. 3, wherein the data center 16 or one or more computers in connection therewith, will both apply the coupon and effect the payment of the transaction in the first utility unit, which here is currency. After step 50, a determination is then made as to whether there was a tip 32 associated with the restaurant bill 23, as shown at decision 52. There is not a tip 32 associated with the restaurant bill 23 at decision 52, then the process applies the coupon to the payment transaction and terminates, as shown at termination 54.

Otherwise, if there is a tip 32 associated with the restaurant bill 23 at decision 52, then, in this embodiment, a determination is made as to whether the waiter 22 is known as a user of the system 10, as shown at decision 56. If the waiter 22 is not known to the system 10 then the restaurant is informed that the waiter 22 is not a known user of the system, i.e., that the system 10 cannot effect any payment of secondary utility unit here, and then the process forwards to step 66 to store data on the transaction, and then the process terminates as shown at termination 68. Otherwise, at decision 56, if the waiter 22 is known to the system 10, then a determination is made as to whether the tip 32 amount is proper for the original undiscounted bill amount 26, as shown at decision 60.

If the tip 32 amount is proper at decision 60, then the process forwards to step 66 to store transaction data and the process terminates at termination 68. Otherwise, if the tip 32 amount is not proper at decision 60, then the process calculates the discrepancy in the first utility unit of the transaction, such as cash, and determines the requisite number of secondary utility units, such as coupons, vouchers, credit units, etc., to make the user not disadvantaged in the transaction, as shown at step 62. Then the second utility units are sent to the account of the user, which here is a waiter 22, as shown at step 64. The data on the transaction is then stored as shown at step 66 and the process then terminates as shown at termination 66.

FIG. 5 is a flowchart of one embodiment of a process to compensate a customer 34 at a retail store for the purchase of expensive items that can be found at lower prices in the region of the customer 34. The economic disadvantage can this be mitigated through the use of secondary utility units, like coupons, allocated either in the payment transaction itself, or allocated to the account of the customer 34 for later use for value. One embodiment of the system 10 is shown in FIG. 3 with a wireless payment terminal 18 at a retail checkout counter 36. The process begins with the receipt of an e-payment request at the retail location, such as at checkout counter 36, as shown in step 70.

A determination is then made as to whether any of the items in the purchase, such as item 35, has a lower price in the geographic region than what the retail establishment is charging for it, as shown at decision 72. The economic calculation can be based on other calculations such as regional price comparison, temporal price comparison, quantity comparison (e.g., a better purchase is of a different quantity), the availability of coupons to the transaction, and the like. If there is not a lower price for the item at decision 72, then the process forwards to step 78 to effect the electronic payment of the retail purchase with any discount (in this process branch, there being none) and the process then terminates as shown at termination 80.

Otherwise, if there is a lower price for the item, such as item 35, at decision 72, then a calculation is made to determine the value of second utility units, such as coupons, vouchers, rebates, or credit units, necessary to offset the discrepancy in price for the item 35 in the first utility unit, as shown at step 74. Then the calculated second utility units are sent to the account of the user of the system 10, which here is customer 34, as shown at step 76, and the electronic payment is effected with the discount applied, as shown at step 78, and the process terminates, as shown at termination 80. The customer 34 account can be held on the database 15 as shown in FIG. 1.

There can be other embodiments of the process in FIG. 5, such as directly sending a coupon to the wireless device 14 of the customer 34, and potentially sending direction to the customer 34 on how and where to use the coupon. In one embodiment, the system 10, will include shopping knowledge of the customer 34, stored at data center 16 and/or database 15, and can use that knowledge to increase the value of the coupon, rebate, voucher, etc., to that particular customer 34. For example, the system 10 may know that customer 34 shops frequently at a pet food store, but is currently making a purchase of goods at a sporting goods store. The system can determine that pet food coupons can be of greater value to the customer 34 in their next pet food purchase transaction than would be the coupon to the current sporting goods transaction. Of course, the system 10 could provide a coupon choice to the customer 34 at checkout, such as whether to apply one coupon in the current transaction or receive credit for a different coupon in another transaction.

In an alternate embodiment, the system and method can be used in multiparty transactions that do not involve the direct payment of money for the exchange of resources. For example, in a resource allocation transaction, such with an Internet resource provider allocating bandwidth based one or more of the parties providing the provider advertising space within a stream, who could be resident at a third party server 17 as shown in FIG. 1, a party, such as a user 22, can provide secondary utility units to the bandwidth provider to get more bandwidth allocation. Thus, in this embodiment, a bandwidth provider that provides a limited amount of bandwidth to a user, such as an ad-stream within and online action such as the streaming of live event or movie, the user 22 wanted to have as much bandwidth as possible to stream data to persons across the Internet. In these situations, many times, the user 22 will not be paying money necessarily to the bandwidth provider but may be trading ad space or other in-stream resources back to the provider (such as ad-shares) and will share in the advertising revenue with the provider. Thus, a party (user 22) who may be otherwise disadvantaged in a pure bandwidth stream allocation as a first utility unit (such as bandwidth needed), can influence the provider by providing lesser advertising space for the provider in the allocated bandwidth and add second utility units, such as virtual coupons or other media, to the provider-beneficial stream to increase the advertising effectiveness, e.g., click-throughs, etc. Such incentive can increase the overall utility to the provider and induce them to let a party (user 22) get a greater allocation of bandwidth with less advertising space for the provider based on the value to the provider of the secondary utility units. For example, a user 22 that has a tremendous bandwidth need due to data-using graphics can better compete with others that need less bandwidth from the provider and may not be otherwise shut out of the bandwidth allocation multiparty transaction.

It can be seen that, in one embodiment, the system 10 can become a third party system, such effected on third party server 17, that can allocate the advantages in a multiple coupon market (second utility unit) such that the economic allocation can be given to the urban store. For example, under the embodiment of third party coupon allocation system, the coupons of many different goods and services can be allocated to a customer to provide an economic benefit in a transaction in one retail store using coupons for another retail store. In the example above, the coupons for the pet food store are being used to economically benefit both the sporting goods store and the customer in the purchase transaction for sporting goods. The economic disadvantage for the high-overhead retailer in a specific item purchase transaction is thus mitigated.

It should also be seen that the system 10 can provide an advantage to a retail store in that it can provide a second utility unit market, e.g., an aggregation of coupons of many retailers, which can allow the grocery store that has only 50% coupon return, i.e., only 50% of its coupons are ultimately utilized by consumers, to get 75% coupon use from the expanded coupon market, and all of the increased sales therefrom. The system 10 can thereby benefit the store, the third party system itself, and the customer in the overall utility transaction.

Although preferred embodiments of the invention have been disclosed in the foregoing specification, it is understood by those skilled in the art that many modifications and other embodiments of the invention to which the invention pertains will come to mind, having the benefit of the teaching presented in the foregoing description and associated drawings. Moreover, although specific terms are employed herein, they are used in a generic and descriptive sense only, and not for the purposes of limiting the described invention.

What is claimed is:

1. A system for a compensating a party in a disadvantageous multiparty transaction, comprising:
at least one server that is selectively accessible to computer devices across a network;
a database, resident on the at least one server, that stores, at least, information on second utility units that are potentially applicable to multiparty transactions in a first utility unit, the second utility units having a different value than a first utility unit of the transactions;
the server selectively receiving requests from requesting computer devices across the network regarding multiparty transactions in a first utility unit;
the server further determining if any party is disadvantaged in the multiparty transaction;
if one or more disadvantaged parties are present in the multiparty transaction, the server reviewing the database to determine if second utility units are applicable to the multiparty transaction; and
the server selectively allocating second utility units to the one or more disadvantaged parties to the multiparty transaction.

2. The system of claim 1, wherein the server further sending information on available second utility units to the requesting computer device across the network.

3. The system of claim 1, wherein the database further storing a plurality of accounts for potential parties to multiparty transactions, and the server further allocating secondary utility units to the account of a party that is disadvantaged in a multiparty transaction.

4. The system of claim 1, wherein the multiparty transaction is a purchase transaction and the server determines disadvantage of a party based upon a predetermined criteria for financial advantage from the multiparty transaction.

5. The system of claim 1, wherein the server determines disadvantage of a party based upon a predetermined criteria for financial advantage from the multiparty transaction where such criteria is based upon information external to the multiparty transaction.

6. The system of claim 1, wherein the server further effects the multiparty transaction in the first utility unit.

7. The system of claim 6, wherein the second utility units are only held within the database, and wherein server further applies one or more first utility units to the purchase transaction on behalf of the one or more disadvantaged parties.

8. The system of claim 1, wherein the server further sends one or more first utility units to another computer system across the network that effects the multiparty transaction.

9. A system for compensating a party in a disadvantageous transaction, comprising:
a computing means selectively accessible to computer devices across a network and for receiving requests from requesting computer devices across the network regarding multiparty transactions in a first utility unit, and determining if any party is disadvantaged in the multiparty transaction;
a database means, resident on the at least one server, for storing, at least, information on second utility units that are potentially applicable to multiparty transactions in a first utility unit, the second utility units having a different value than a first utility unit of the transactions;
if the computing means determines one or more disadvantaged parties are present in the multiparty transaction, the computing means further for:
reviewing the database means to determine if second utility units are applicable to the multiparty transaction; and
selectively allocating second utility units to the one or more disadvantaged parties to the multiparty transaction.

10. The system of claim 9, wherein the computer means further for sending information on available second utility units to the requesting computer device across the network.

11. The system of claim 9, wherein the database means further for:
storing a plurality of accounts for potential parties to multiparty transactions; and
allocating secondary utility units to the account of a party that is disadvantaged in a multiparty transaction.

12. The system of claim 9, wherein the computing means further for effecting the multiparty transaction in the first utility unit.

13. A method for compensating a party in a disadvantageous transaction, comprising the steps of:
receiving, a least at one server, a request from a requesting computer device across a network, the request regarding multiparty transactions in a first utility unit;
determining, at the at least one server, if any party is disadvantaged in the multiparty transaction;
accessing a database that stores, at least, information on second utility units that are potentially applicable to multiparty transactions in a first utility unit, the second utility units having a different value than a first utility unit of the transactions;
if the computing means determines one or more disadvantaged parties are present in the multiparty transaction, the computing means further for:
reviewing the database means to determine if second utility units are applicable to the multiparty transaction; and
selectively allocating second utility units to the one or more disadvantaged parties to the multiparty transaction.

14. The method of claim 13, further comprising sending information on available second utility units from the at least one server to the requesting computer device across the network.

15. The method of claim 13, wherein the database further storing a plurality of accounts for potential parties to multiparty transactions, and further comprising allocating, at the at least one server, secondary utility units to the account of a party that is disadvantaged in a multiparty transaction.

16. The method of claim 13, wherein the multiparty transaction is a purchase transaction and further comprising, at the at least one server, determining the disadvantage of a party based upon a predetermined criteria for financial advantage from the multiparty transaction.

17. The method of claim 13, further comprising determining, at the at least one server, the disadvantage of a party based upon a predetermined criteria for financial advantage from the multiparty transaction where such criteria is based upon information external to the multiparty transaction.

18. The method of claim 13, further comprising, at the at least one server, effecting the multiparty transaction in the first utility unit.

19. The method of claim 18, wherein the second utility units are only held within the database, and further comprising, at the at least one server, applying one or more first utility units to the purchase transaction on behalf of the one or more disadvantaged parties.

20. The method of claim 13, further comprising sending, from the at least one server, one or more first utility units to another computer system across the network that effects the multiparty transaction.
